(19) United States
(12) Patent Application Publication
(10) Pub. No.: US 2025/0271336 A1
(43) Pub. Date: Aug. 28, 2025

(54) APPARATUS FOR DETECTING A FIRE IN A VEHICLE

(71) Applicants: Siemens Mobility GmbH, München (DE); Siemens Mobility Austria GmbH, Wien (AT)

(72) Inventors: Andreas Häussler, Solingen (DE); Christopher Schatton, Viersen (DE); Fritz Johannes Geruschkat, München (DE); Arleta Waindich, Duisburg (DE); Tobias-Klaus Goertz, Leitzersdorf (AT)

(21) Appl. No.: 18/858,854

(22) PCT Filed: Apr. 14, 2023
(86) PCT No.: PCT/EP2023/059792

§ 371 Date: Oct. 22, 2024

(30) Foreign Application Priority Data
Apr. 22, 2022 (DE) 10 2022 203 931.9

(51) Int. Cl. G01N 1/24

(52) U.S. Cl. CPC G01N 1/24

(57) ABSTRACT

An apparatus detects a fire in a space. The apparatus contains a smoke detector with a test chamber, at least one air inlet and at least one air outlet. The apparatus further has at least one device, that is connected to the at least one air outlet, for generating a suction for air from the air outlet so that air is suctioned from the space through the air inlet into the test chamber and discharged through the air outlet. The apparatus is configured for use in a vehicle including passenger transportation vehicles.

The invention relates to an apparatus for detecting a fire in a space, said apparatus comprising a smoke detector having a test chamber and at least one air inlet and at least one air outlet, and to a vehicle comprising at least one apparatus for detecting a fire.

Smoke detectors for fire detection are known in various designs. They are usually disposed on the ceiling of a space to be monitored, so that rising smoke or combustion gases in the space can be detected, e.g. optically, in a test chamber of the smoke detector and a warning signal issued.

In public transportation vehicles, however, openly accessible smoke detectors are subject to vandalism. Although concealed mounting has the advantage of protecting the smoke detectors against vandalism and making them less likely to become contaminated by organic or textile fibers or particles, for example, reliable operation is still not guaranteed due to unfavorable pressure conditions on or behind an intermediate ceiling or side wall, since smoke or combustion gases from the space cannot reliably reach the test chamber of the smoke detector due to the flow and pressure conditions.

The publication DE 103 19 688 B4 describes disposing a smoke detector in an aircraft's exhaust air duct behind a protective grille or cover at the entrance to the exhaust air duct.

The object of the invention is to provide a reliable fire detection system in public spaces.

This object is achieved as claimed in independent claim 1. Further developments and embodiments of the invention are set forth in the features of the dependent claims.

An apparatus according to the invention for detecting fire in a space comprises a smoke detector having a test chamber and at least one air inlet and at least one air outlet, wherein the apparatus comprises at least one device, connected to the at least one air outlet, for producing suction for air from the air outlet, so that air from the space is drawn through the air inlet into the test chamber and discharged through the air outlet.

The test chamber of the smoke detector is used to detect smoke or fumes and is suitably designed for this purpose. The test chamber is open toward at least one air inlet of the smoke detector, so that air flowing through the air inlet, in particular from the space to be monitored, reaches the test chamber. The test chamber is similarly open to the at least one air outlet of the smoke detector, so that air from the test chamber can flow out of the air outlet. The air outlet is fluidically connected to a device for generating suction for air at the air outlet. The air inlet and the air outlet are disposed in relation to the test chamber such that air that is drawn in through the air inlet and discharged through the air outlet flows through the test chamber.

A vehicle according to the invention (e.g. for public transportation), particularly a large-capacity vehicle—this includes land, air and watercraft—comprises at least one apparatus according to the invention for fire detection in a space. The space can be a cubicle, for example for passengers, such as a sanitary unit of the vehicle. The apparatus for detecting fire in a space is suitably disposed in or on the cubicle.

The device for generating suction at the air outlet is in particular a system or a technical device and could thus also be referred to as an apparatus.

In one development, the device for generating suction for air from the air outlet comprises a negative-pressure line—the relative pressure in the negative-pressure line is lower than in the space. The air pressure in the space corresponds, for example, to the atmospheric ambient pressure. The lower relative pressure generates suction at the air outlet. The negative-pressure line can also be used to remove air from the smoke detector. The negative-pressure line can, for example, be connected to a negative pressure system of the vehicle. The air outlet is further connected to an exhaust air system of the vehicle.

To generate the negative pressure on the air outlet side, which can also be referred to as the venting pressure, the device for generating the suction can also comprise one or more devices for conveying fluids, in this case air, e.g. a suitably designed and mounted fan, a suitably designed and mounted venturi nozzle, a suitably designed and mounted pump or a suitably designed and mounted ejector, in particular a feed ejector. The fan, venturi nozzle, pump or ejector can, for example, be disposed in the negative-pressure line so that a negative pressure is generated between the air outlet and the fan, venturi nozzle, pump or ejector, thus producing suction for air at the air outlet of the smoke detector. Air is thus removed from the test chamber of the smoke detector through the air outlet by means of the at least one device. At the same time, air is also drawn into the test chamber through the air inlet of the smoke detector due to the suction.

According to another development, the apparatus comprises a space-defining, e.g. planar, element of the space, such as a wall or ceiling of the space or a wall or ceiling cladding, e.g. in the form of a panel, or a cover of the smoke detector, wherein the smoke detector is disposed on a side of the space-defining element facing away from the space, and wherein an opening is provided in the space-defining element in the region of the at least one air inlet of the smoke detector and is disposed such that at least the at least one air inlet of the smoke detector is uncovered toward the space by virtue of the opening in the space-defining element to allow an air flow from the space, thus providing an open flow path, so that air can flow from the space to the test chamber of the smoke detector.

In one development, the air outlet can be disposed on the side of the element facing away from the space, so that air is drawn out of the smoke detector and thus also out of the space through the air inlet into the test chamber and out of the test chamber through the air outlet.

According to another development, the test chamber of the smoke detector is disposed in an otherwise airtight housing comprising the at least one air inlet and the at least one air outlet. The smoke detector accordingly has a housing with the at least one air inlet and the at least one air outlet, wherein the test chamber is disposed in the housing and wherein the housing, apart from the air inlets and outlets, is designed to be airtight. The test chamber can be enclosed in an airtight manner by the housing, with the at least one air inlet in the housing to the test chamber and the at least one air outlet of the test chamber.

Another development provides that the apparatus for detecting fire comprises a commercially available smoke detector which is disposed on the side of the space-defining element facing away from the space in the region of the at least one opening in the space-defining element in such a way that air from the space can flow freely through the at least one opening in the space-defining element to the test chamber of the smoke detector, wherein the smoke detector is encapsulated in an enclosure that is connected to the space-defining element in an airtight manner, wherein the at least one opening in the space-defining element forms the at least one air inlet of the smoke detector and wherein the space-defining element is otherwise designed to be airtight, wherein the enclosure contains the air outlet that is connected to the device for generating suction for air from the air outlet, so that air from the space is sucked through the air inlet into the test chamber and is discharged through the air outlet, and otherwise encloses the smoke detector in an airtight manner.

The space-defining element, e.g. a ceiling or wall panel, is designed to be airtight at least in the region of the enclosure connected to it. The enclosure, which is designed to be cap-shaped, for example, and the space-defining element thus form a housing that is airtight apart from the air inlets and outlets.

Advantages of the invention include, in particular, the active and therefore reliable air inflow to the smoke detector. Even in the event of unfavorable airflow conditions in a space, such as in a sanitary unit of a public transportation rail vehicle, which is often ventilated by means of fans and has a slight negative pressure compared to other passenger spaces of the rail vehicle, smoke can be reliably conveyed to the test chamber and detected there. The invention also makes it possible to conceal the smoke detector behind space-defining elements, e.g. to mount it behind an intermediate ceiling. This protects it from vandalism and also eliminates obtrusive features from the cubicle design.

The invention allows for numerous embodiments. It will now be explained in more detail with reference to the following figures, each showing an exemplary embodiment. Identical elements are provided with the same reference characters in the figures.

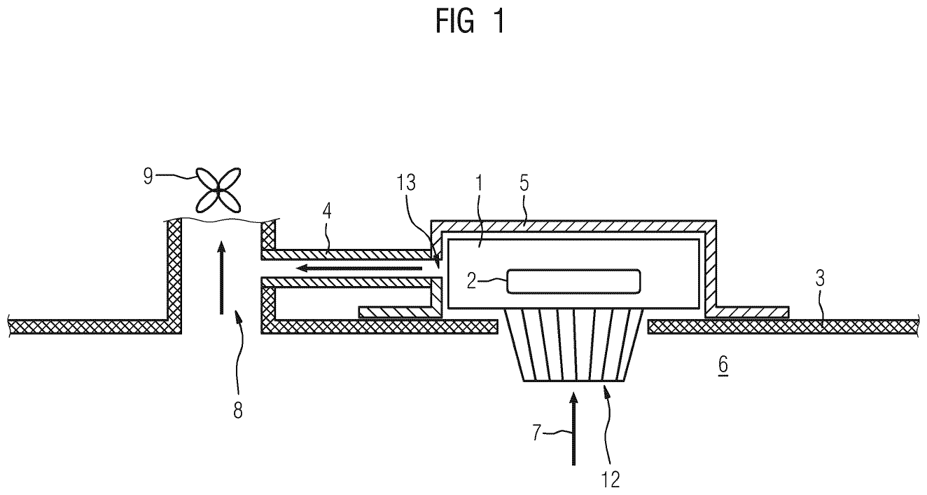

FIG. 1 shows a schematic sectional view of a first embodiment of an inventive apparatus for detecting fire,

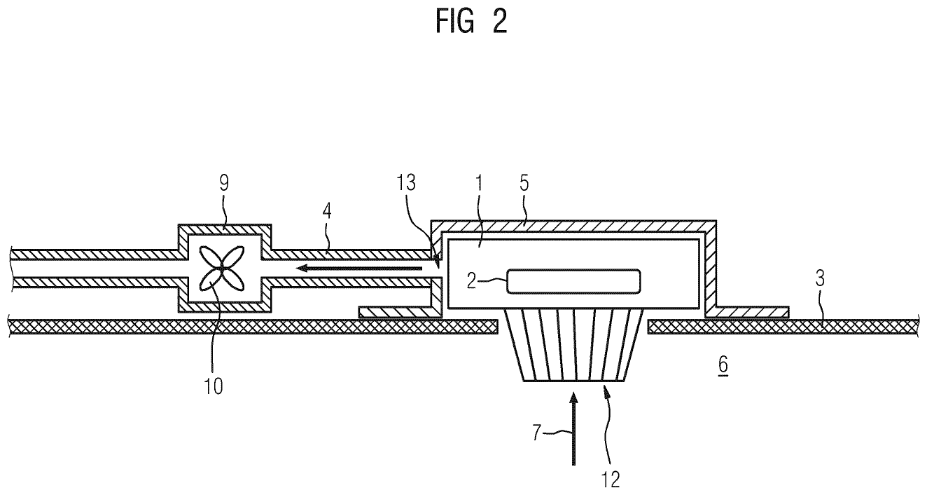

FIG. 2 shows a schematic sectional view of a second embodiment of an inventive apparatus for detecting fire,

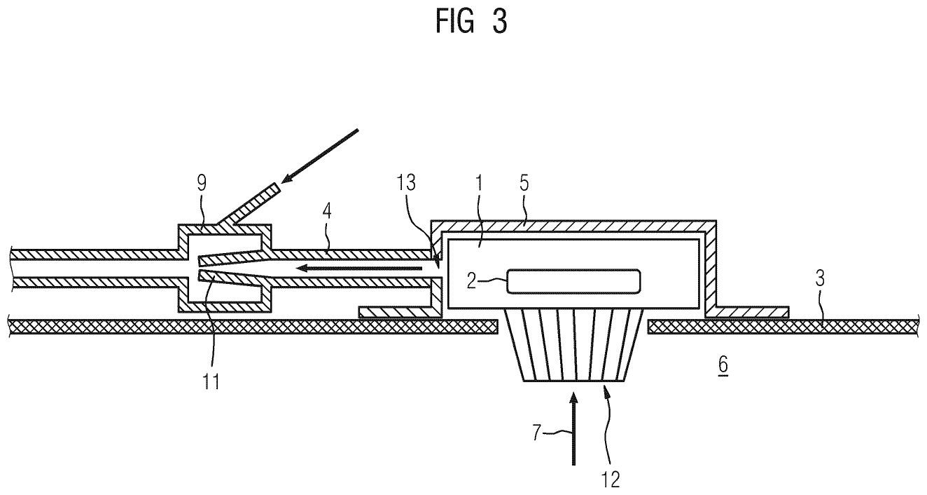

FIG. 3 shows a schematic sectional view of a third embodiment of an inventive apparatus for detecting fire,

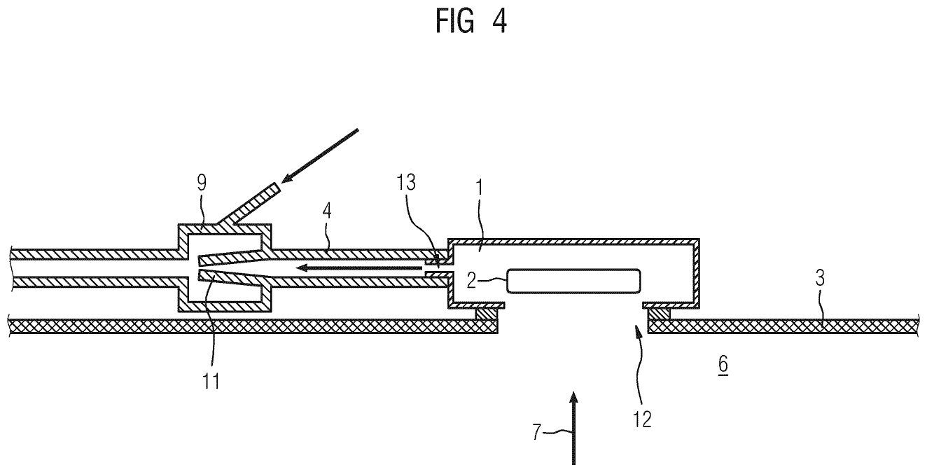

FIG. 4 shows a schematic sectional view of a fourth embodiment of an inventive apparatus for detecting fire.

FIG. 1 shows a schematic sectional view of a first embodiment of an inventive apparatus for detecting fire in a space 6. The apparatus comprises a smoke detector 1 having a test chamber 2. In this illustrative example, the smoke detector 1 is a commercially available smoke detector. It is disposed on a side of an element 3 defining the space 6, e.g. a ceiling or wall cladding, said side facing away from the space 6.

The element 3 defining the space 6 has an opening for the passage of air from the space 6, wherein the smoke detector 1 is disposed in the region of the opening such that air from the space 6 can flow to the test chamber 2 of the smoke detector. The opening in the element 3 defining the space 6, e.g. an opening in the wall or ceiling cladding, is used here as the air inlet 12 of the smoke detector 1. This is open toward the space 6. The test chamber 2 of the smoke detector is also open toward the air inlet 12, so that air can flow from the air inlet 12 to the test chamber 2. Thus, air from the space 6 can flow freely through the air inlet 12 to the test chamber 2 of the smoke detector 1.

The smoke detector 1 is also enclosed in an airtight, here cap-shaped enclosure 5. The cap-shaped enclosure 5 is connected in an airtight manner to the element 3 defining the space 6. Apart from the air inlet 12, the element 3 defining the space 6 is also designed to be airtight, at least in the region of the enclosure 5. The smoke detector 1 is thus encapsulated in an airtight manner in the enclosure 5 and the element 3 defining the space 6. The enclosure 5 and the element 3 defining the space 6 could be regarded as an additional housing around the smoke detector.

The enclosure 5 has an air outlet 13 which is connected to a negative-pressure line 4, e.g. a conduit. The negative pressure in the negative-pressure line 4, i.e. a relative pressure that is at least a predetermined amount lower than in the space 6, such as an ambient pressure predominantly present in the space, is produced by means of a device 9 for generating suction for air from the air outlet 13. In this case, the device 9 for generating suction is a ventilation unit of an exhaust air system of a rail vehicle, which is used to extract air from the space 6 and has an extractor line 8 open to the space 6. The device 9 for generating suction could also be referred to as an extraction apparatus. The negative-pressure line 4 is fluidically connected to the extractor line 8.

The lower relative pressure at the air outlet 13, at least in comparison to the air inlet 12, produces a suction effect that draws air from the space 6 to the air inlet 12 and on into the test chamber 2 of the smoke detector 1 and out of the test chamber 2 through the air outlet 13.

The arrows indicate the respective air flows. Thus, smoke or combustion gases, indicated by the arrow 7, would also reliably reach the smoke detector 1, although air from the space 6 is also discharged through the extractor line 8. The extractor line 8 and the air inlet 12 are spaced at least a predefined distance apart.

The exemplary embodiments of FIG. 2 and FIG. 3 differ only in the type of ventilation and thus in the design of the device 9 for generating the suction at the air outlet 13. According to the embodiment in FIG. 2, a separate fan 10 is disposed in the negative-pressure line 4 to provide suction during operation. In FIG. 3, on the other hand, an ejector, in this case a feed ejector 11, is connected to the negative-pressure line 4 and generates the suction on the air outlet side. The end of the negative-pressure line 4 can be outside the space 6; for example, it can also be routed out of the rail vehicle and have an open end toward the exterior environment of the rail vehicle, allowing the extracted air from the space to be released into the environment. For example, the feed ejector 11 with a Venturi nozzle as illustrated here is supplied with compressed air from a compressed air system and uses the jet pump principle to generate a negative pressure on the side comprising the negative-pressure line 4 of the air outlet 13.

The space 6 can be a cubicle or sanitary unit of a rail vehicle that has a ventilation system to which the negative-pressure line 4 is connected, as in the design example according to FIG. 1, or it can be a passenger space in general, for example a compartment, of a rail vehicle and the device 9 for generating suction is separate from other ventilation systems of the vehicle and can be operated independently of them if necessary, as illustrated in FIGS. 2 to 4.

FIG. 4 shows a further embodiment of the invention. Here too, the ventilation pressure is generated by means of a feed ejector 11, as in FIG. 3. Here, however, the smoke detector 1 itself has an airtight housing around the test chamber 2 with the air inlet 12 and the air outlet 13 which is connected to the feed ejector 11 by means of the negative-pressure line 4. The air inlet 12 of the smoke detector 1 is in turn disposed in the region of the opening of the element 3 defining the space 6, so that air from the space 6 is sucked through the air inlet 12 into the test chamber 2 and is discharged through the air outlet 13 into the negative-pressure line 4.

Not shown is an example with an air outlet open to the immediate environment, as could be used, for example, if the relative pressure in the space is higher than outside the space where at least the air outlet of the smoke detector, in particular the entire smoke detector, is disposed. The device for generating suction would thus produce a negative pressure on the side of the space-defining element facing away from the space or, if necessary, a positive pressure in the space, thereby producing the suction.

1-10. (canceled)

11. An apparatus for detecting fire in a space, the apparatus comprising:
a smoke detector having a test chamber, at least one air inlet, and at least one air outlet; and
at least one device, connected to said at least one air outlet, for generating suction for air from said at least one air outlet, so that the air is drawn out of the space through said at least one air inlet into said test chamber and is discharged through said at least one air outlet.

12. The apparatus according to claim 11, further comprising an airtight housing defining said at least one air inlet and said at least one air outlet of said smoke detector, said test chamber of said smoke detector is disposed in said airtight housing.

13. The apparatus according to claim 11, wherein said at least one device for generating suction includes a negative-pressure line.

14. The apparatus according to claim 11, wherein said at least one device for generating suction includes a fan, a venturi nozzle, a pump or an ejector.

15. The apparatus according to claim 11, further comprising an element defining the space, wherein said smoke detector is disposed on a side of said element facing away from the space, wherein said element defining the space has at least one opening formed therein in a region of said at least one air inlet of said smoke detector such that said at least one air inlet of said smoke detector is uncovered toward the space through said at least one opening in said element defining the space.

16. The apparatus according to claim 15, wherein said at least one air outlet is disposed on said side of said element defining the space facing away from the space, so that the air is discharged from the space through said smoke detector.

17. The apparatus according to claim 15,
wherein said smoke detector is a commercially available smoke detector disposed on said side of said element defining the space facing away from the space in said region of said at least one opening in said element defining the space such that the air from the space can flow freely through said at least one opening in said element defining the space to said test chamber of said smoke detector;
further comprising an enclosure, said smoke detector is encapsulated in said enclosure, said enclosure is connected in an airtight manner to said element defining the space;
wherein said at least one opening in said element defining the space forms said at least one air inlet;
wherein said element defining the space is configured airtight; and
wherein said enclosure contains said at least one air outlet which is connected to said at least one device for generating suction for the air from said at least one air outlet, so that the air is drawn out of the space through said at least one air inlet into said test chamber and is discharged through said air outlet, and said enclosure is configured airtight.

18. A passenger transportation vehicle, comprising:
said apparatus according to claim 11.

19. The passenger transportation vehicle according to claim 18, further comprising at least one cubicle in or on which said apparatus is disposed.

20. The passenger transportation vehicle according to claim 18, further comprising an exhaust air system, said at least one air outlet is connected to said exhaust air system of the vehicle.
